(19) United States
(12) Patent Application Publication
(10) Pub. No.: US 2007/0261816 A1
(43) Pub. Date: Nov. 15, 2007

(54) HOOD MOUNTED HEAT EXCHANGER

(76) Inventors: Charles J. Warren, Sarver, PA (US); Shawn J. Murtha, Irwin, PA (US); Todd L. Summe, Pittsburgh, PA (US); John W. Cobes, Lower Burrell, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 11/691,763

(22) Filed: Mar. 27, 2007

Related U.S. Application Data
(60) Provisional application No. 60/786,310, filed on Mar. 27, 2006.

(51) Int. Cl. B60H 1/32

(52) U.S. Cl. 165/41

(57) ABSTRACT

The invention in one embodiment provides a cooling structure including a body panel including an air intake and exhaust; and a heat exchanger integrated between the air intake and the exhaust of the body panel, the heat exchanger comprising a plurality of channels for circulating coolant.

### CROSS REFERENCE TO RELATED APPLICATION

The present invention claims the benefit of U.S. provisional patent application 60/786,310 filed Mar. 27, 2006 the whole contents and disclosure of which is incorporated by reference as is fully set forth herein.

### FIELD OF THE INVENTION

The present invention relates to cooling in automotive applications.

### BACKGROUND OF THE INVENTION

Many types of vehicles utilize a heat exchanger, commonly known as a radiator, to dissipate heat from engine coolant to the ambient air. Such radiators often include a radiator core having a plurality of tubes, through which the coolant flows. The tubes are spaced apart from one another by fins which conduct heat away from the tubes, and dissipate the heat to ambient air which is drawn or forced through the fins between the tubes. To facilitate heat transfer and construction of the radiator, the tubes typically have an elongated rectangular cross-section, with long side walls extending through the radiator core for contacting the fins, and short end walls joining the two side walls of the tubes. Typically, in front engine mounted vehicles the radiator is mounted at the front end of the vehicle. Referring to FIG. 1, mounting of the radiator 3 at the vehicle's front end reduces design flexibility, since the size of the radiator 3 typically dictates the vehicle front end dimensions.

### SUMMARY OF THE INVENTION

In one embodiment, a cooling structure is provided including a multi-layer sheet-type heat exchanger and air intake that is integrated into a vehicle body panel. In one embodiment, the heat exchanger includes:

a body panel including an air intake and exhaust; and

a heat exchanger integrated between the air intake and the exhaust of the body panel, the heat exchanger comprising a plurality of channels for circulating engine coolant.

In one embodiment, the cooling structure includes a heat exchanger of multi-layer structure. In one embodiment, heat exchanger is a multi-layer structure of sheet structures, in which each sheet structure including a plurality of channels formed by the joining of at least two metal sheets. In yet another embodiment, the heat exchanger comprises aluminum. In an even further embodiment, the heat exchanger is a multi-layer structure that includes a header pipe having a coolant inlet and coolant return to a vehicle engine. In one embodiment, the body panel to which the heat exchanger is integrated comprises aluminum. In one embodiment, the cooling structure further includes the blower is positioned to pull air into the air intake. In one embodiment, the blower is a centrifugal type blower powered by an electrical motor.

In another aspect of the present invention, a heat exchanger is provided integrated into the roofline of a vehicle. In one embodiment, the heat exchanger includes:

a vehicle roofline including an air intake and exhaust; and

a heat exchanger integrated into the roofline between the air intake and the exhaust.

In one embodiment, the heat exchanger may be an AC condenser that is mounted in an air intake of the vehicle's roof. In another embodiment, the heat exchanger may cool engine coolant.

### BRIEF DESCRIPTION OF THE DRAWINGS

The following detailed description, given by way of example and not intended to limit the invention solely thereto, will best be appreciated in conjunction with the accompanying drawings, wherein like reference numerals denote like elements and parts, in which:

FIG. 1 (prior art) is a side cross-sectional view of conventional radiator mounted in the front of the vehicle.

FIG. 2 is a perspective view of one embodiment a hood mounted heat exchanger in accordance with the present invention.

FIG. 3 is a side cross-sectional view of one embodiment a hood mounted heat exchanger, blower, and intake in accordance with the present invention.

FIG. 4 is a side cross-sectional view of one embodiment a hood mounted heat exchanger in a vehicle in accordance with the present invention.

FIGS. 5a and 5b are side cross-sectional views of one embodiment a vehicle having a roof mounted heat exchanger in accordance with the present invention.

### DETAILED DESCRIPTION OF PREFERRED EMBODIMENTS

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

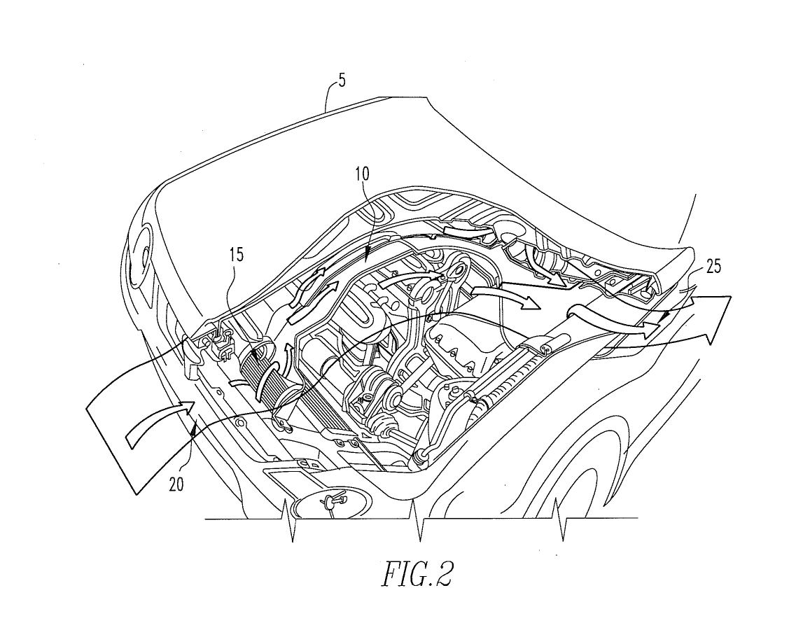

In one embodiment, the present invention provides a vehicle structure that includes a body panel including an air intake and exhaust; and a heat exchanger integrated between the air intake and the exhaust of the body panel, the heat exchanger comprising a plurality of channels for circulating coolant. The body panel may include any component used in vehicle transportation including but not being limited to hood panel, roof panel, trunk lid panel, outer fender, inner fender, firewall, floor panel, or quarter panel. FIG. 2 depicts a perspective view of a hood mounted cooling structure including a multilayer sheet-type heat exchanger 10, a blower 15, air intake 20 and exhaust vent 25, each of which is integrated into the vehicle's hood 30. Although, FIGS. 2-4 depict a vehicle hood, it is noted that the present disclosure is equally applicable to any vehicle body panel. It is further noted that although FIGS. 2-4 depict an arrangement suitable for engine coolant, the heat exchanger of the present invention is suitable for any cooling purposes including but not being limited to engine coolant and air conditioning applications.

The heat exchanger 10 may be a multi-layer structure formed of metal sheet. A heat exchanger is a structure that reduces the temperature of liquids that are circulated through it. In one embodiment, the heat exchanger is formed of an aluminum alloy. As used herein the term aluminum alloy means an aluminum metal with soluble alloying elements either in the aluminum lattice or in a phase with aluminum. Alloying element include but are not limited to Cu, Fe, Mg, Ni, Si, Zn, Mn, Ti, Cr, V, Ag, Sn, Sc, and Li. It has also been contemplated that the heat exchanger may be composed of copper.

The term multi-layer denotes that the heat exchanger may be constructed of a number of layers of sheet structures containing coolant channels. In one embodiment, the multi-layer sheet structure includes three sheet structures, in which the sheet structure includes a plurality of coolant circulating channels. In another embodiment, the multi-layer sheet structure includes five sheet structures, in which the sheet structure includes a plurality of coolant circulating channels. In one embodiment, the heat exchanger further includes fins between each sheet structure, wherein the fins further increases the surface area of the heat exchanger for cooling.

A sheet structure containing cooling channels includes at least two layers of metal sheet being selectively metallurgically bonded, where the sites at which the two layers are metallurgically bonded define a channel for containing and circulating coolant. In one embodiment, each sheet structure is separated to allow for the flow of air across the layers. In one embodiment, the multilayer sheet-type heat exchanger 10 further includes a header pipe (not shown) having a coolant inlet and coolant return to the vehicle's engine.

In one embodiment, the multi-layered heat exchanger is provided by brazing at least two sheets of aluminum to form a sheet structure containing channels for circulating coolant. Brazing is a joining process whereby a non-ferrous filler metal or alloy is heated to melting temperature and distributed between two or more close-fitting parts by capillary action. At liquid temperature, the molten filler metal and flux interact with the base metal, cooling to form a joint.

In one embodiment, the multi-layered heat exchanger may be brazed in a vacuum furnace. In one embodiment, a multi-layered heat exchanger is provided in a vacuum furnace using a core sheet alloy, such as Aluminum Association 6063, 6061 or 3005, and a clad alloy of Aluminum Association 4004, 4104 or 4147. The clad alloy is the component that when under heat and vacuum, melts and fuses with the core alloy to provide the channels of the sheet structures. In another embodiment, the multi-layered heat exchanger may be brazed in a controlled atmosphere brazing (CAB) process using a flux of Potassium Al-fluoride; core sheet alloy, such as Aluminum Association 3003; and a clad or foil interlayer of Aluminum Association 4045 or 4343. The clad or foil interlayer is the component that when under heat and vacuum, melts and fuses with the core alloy to provide the channels of the sheet structures.

In another embodiment, the sheet structures of the multi-layered heat exchanger may be formed using a tube and sheet process. Tube and sheet processing includes at least the steps of providing a first sheet material, such as Aluminum Association 3003 or 6061; placing a stencil of the coolants channels atop the first sheet material; and then applying a high temperature material to the first sheet and stencil, where the stencil allows for the high temperature material to be applied to the portion of the sheet at which the channels are desired. The term high temperature material means a material that when placed between two materials does not allow for metallurgical bonding, in which one example includes carbon paste. Other examples include ceramics materials such as Silicon Nitride or Alumina paste.

In a next process step, a second sheet of metal, such as Aluminum Association 3003 or 6061, is placed atop the first sheet and the high temperature material, and the two sheets are subjected to a temperature and pressure sufficient to cause metallurgical bonding between the portions of the sheet devoid of the high temperature material of which the two metal sheets are in contact. The pressure and temperature sufficient to result in metallurgical bonding may be provided by a combination of rollers and furnaces. In a next step, the portions of the two sheets at which a metallurgical bond is not formed are subjected to the application of a pressure, and expand to form a channel. The pressure may be provided by liquid or air pressure. In one embodiment, the material and thickness of the sheet may be selected so that only one of the sheets deforms in response to the pressure, and provides a sheet in which only one surface of the sheet structure provides visual indication of the channel structure. In one embodiment, the surface that does not reflect the channel structure may be suitable for exterior body panels of a vehicle.

In one embodiment, to provide a multi-layer heat exchanger, multiple sheet structures may be formed together using the methods described above. In another embodiment a number of individual sheet structures of channels may be mechanically fastened together, and communication between the channels of the individual sheet structures may be provided by tube structures extending between each of sheet structures.

In one embodiment, the multi-layer heat exchanger is integrated into a body panel. The term integrated means that the heat exchanger may be mechanically fastened or formed into the body panel. In one embodiment, the heat exchanger may be formed into the body panel by producing the sheet using the tube and sheet process described above and then stamping the sheet to provide the desired shape and geometry of the body panel. Following stamping pressure may be applied, via water or air, to the portions of the layered sheet that are not metallurgically bonded to provide the channel structure. In one embodiment, the heat exchanger may be integrated mechanically by fasteners, such as nut and bolt arrangements. In one embodiment, a heat shield formed of an insulating material, such as fiberglass, or refractory material is mounted between the heat exchanger and the body panel to which the heat exchanger is mounted.

FIG. 2 depicts one embodiment of the heat exchanger of the present invention being integrated into hood panel. In one embodiment, the hood 30 includes an air passage including an air intake 20 and an exhaust vent 25 that directs air flow over the heat exchanger 10. As depicted in FIG. 2, the air flow is illustrated as entering the air intake 20 above the vehicle's grille, passing over through the multilayer sheet-type heat exchanger 10 and being vented through the side of the hood 30 through the exhaust vent 25.

FIG. 3 depicts a side cross-sectional view of a hood mounted heat exchanger 10, blower 15, and intake 20 in accordance with the present invention. The blower 15 is preferably a centrifugal type blower powered by an electrical motor. The blower 15 is positioned to pull air into the air intake 20 and over the multilayer sheet-type heat exchanger 10. As depicted in FIG. 3, the air passes over both the upper and lower surfaces of the multilayer sheet-type heat exchanger 10.

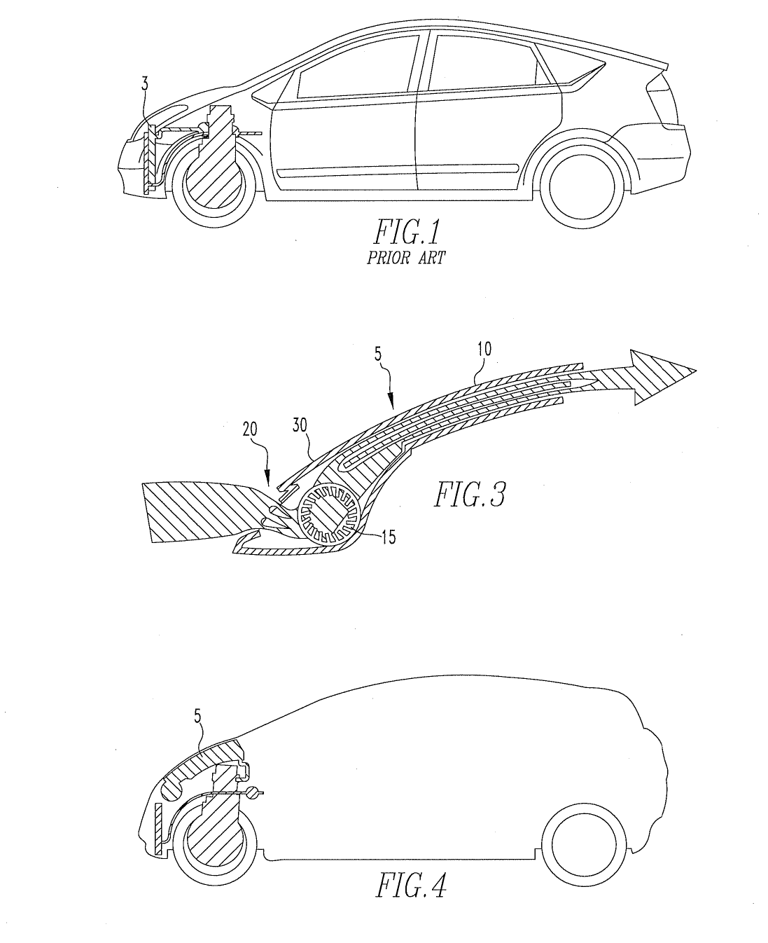

FIG. 4 is a side cross-sectional view of the hood mounted cooling structure of the present invention within a vehicle. FIG. 4 depicts the connection of the hood mounted cooling structure 5 to the engine 50. In comparison to prior designs having a conventional radiator, as depicted in FIG. 1, the hood mounted cooling structure 5 of the invention increases the free space at the front end of the vehicle.

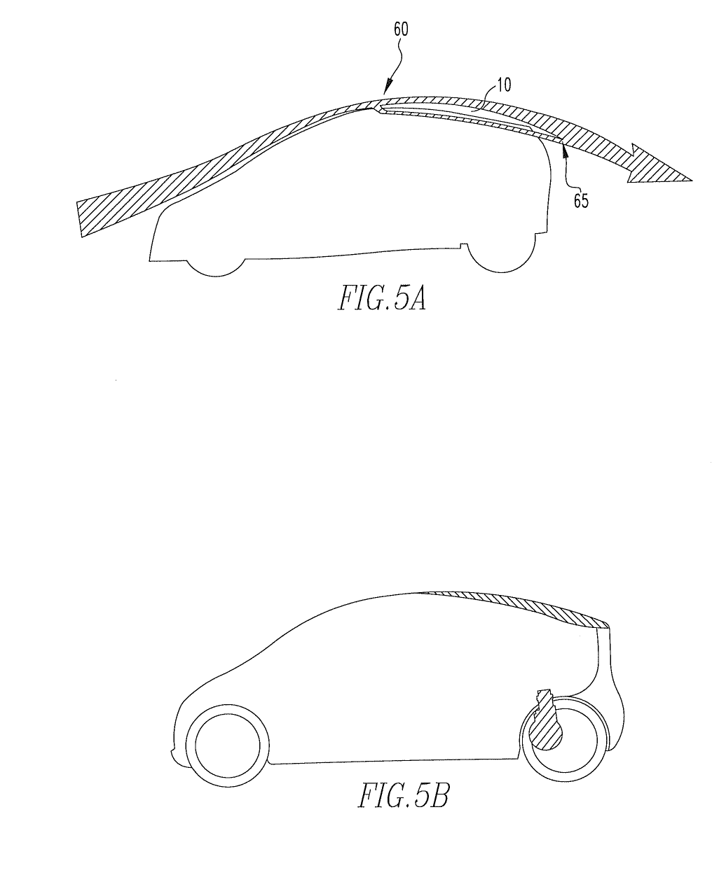

FIGS. 5a and 5b are side cross-sectional views of a vehicle having a roofline cooling structure. In this embodiment, the vehicle roofline includes an air intake 60 and exhaust 65, in which a heat exchanger 10 is integrated into the roofline between the air intake 60 and the exhaust 65. The heat exchanger 10 integrated into the roofline may be an AC condenser, and may include a multilayer-sheet heat exchanger, as described above with reference to FIGS. 2-4. Alternatively, the heat exchanger 10 integrated into the roofline provides engine cooling, as depicted in FIG. 5b. The roofline cooling structure may also include a blower at the intake to increase airflow across the heat exchanger 10.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

What is claimed is:

1. A cooling structure comprising:
a body panel including an air intake and exhaust; and
a heat exchanger integrated between the air intake and the exhaust of the body panel, the heat exchanger comprising a plurality of channels for circulating coolant.

2. The cooling structure of claim 1, wherein the heat exchanger is a multi-layer structure.

3. The cooling structure of claim 1, wherein the heat exchanger is a multi-layer structure of sheet structures.

4. The cooling structure of claim 1, wherein at least one of the sheet structures includes the plurality of channels formed by the joining of two metal sheets.

5. The cooling structure of claim 1, wherein the heat exchanger comprises aluminum.

6. The cooling structure of claim 3, wherein the multi-layer heat structure comprises three layers.

7. The cooling structure of claim 3, wherein the multilayer structure comprises a header pipe having a coolant inlet and coolant return to a vehicle engine.

8. The cooling structure of claim 1, wherein the body panel comprises aluminum.

9. The cooling structure of claim 1, further comprises a blower is positioned to pull air into the air intake.

10. The cooling structure of claim 9, wherein the blower is a centrifugal type blower powered by an electrical motor.

11. The cooling structure of claim 1, wherein the heat exchanger is formed into the body panel.

12. The cooling structure of claim 1, wherein the heat exchanger is mechanically fastened to the body panel.

13. The cooling structure of claim 1, wherein the body panel is a hood.

14. A cooling structure including:
a vehicle roofline including an air intake and exhaust; and
a heat exchanger integrated into the roofline between the air intake and the exhaust.

15. The cooling structure of claim 1, wherein the heat exchanger is an AC condenser.

16. The cooling structure of claim 13, wherein the heat exchanger is a multi-layer structure.

17. The cooling structure of claim 13, wherein the heat exchanger is a multi-layer structure of sheet structures.

18. The cooling structure of claim 17, wherein at least one of the sheet structures includes the plurality of channels formed by the joining of two metal sheets.

19. The cooling structure of claim 14, wherein the heat exchanger comprises aluminum.

20. The cooling structure of claim 14, wherein the multilayer structure comprises a header pipe having a coolant inlet and coolant return to a vehicle engine.
